(19) United States
(12) Patent Application Publication
(10) Pub. No.: US 2009/0056763 A1
(43) Pub. Date: Mar. 5, 2009

(54) Dish washing machine

(76) Inventors: Joon Ho Pyo, Seoul (KR); Yong Jin Choi, Seoul (KR); Seong Ho Kim, Seoul (KR); Jung Youp Han, Seoul (KR); Young Hwan Park, Seoul (KR)

Correspondence Address: MCKENNA LONG & ALDRIDGE LLP, 1900 K STREET, NW, WASHINGTON, DC, 20006, US

(21) Appl. No.: 12/230,609

(22) Filed: Sep. 2, 2008

(30) Foreign Application Priority Data
Aug. 31, 2007 (KR) 10-2007-0088570

(51) Int. Cl. B08B 3/04

(52) U.S. Cl. 134/25.2

(57) ABSTRACT

A controlling method for a dish washing machine that is capable of accomplishing an excellent washing effect while consuming a small amount of energy is disclosed. The controlling method for the dish washing machine includes; spraying a washing water mixed with detergent into a tub containing dishes, spraying washing water that is not mixed with detergent into the tub, spraying steam into the tub after the spraying of washing water that is not mixed with the detergent, and reducing the humidity of the tub.

### CROSS-REFERENCE TO RELATED APPLICATION

This application claims the benefit of Korean Patent Application No. 10-2007-0088570, filed on Aug. 31, 2007, which is hereby incorporated by reference in its entirety as if fully set forth herein.

### BACKGROUND OF THE INVENTION

1. Field of the Invention

The present invention relates to a dish washing machine, and more particularly, to a controlling method for a dish washing machine that is capable of accomplishing an excellent washing effect while consuming a small amount of energy.

2. Discussion of the Related Art

In general, a dish washing machine is a machine that sprays washing water onto dishes placed in a tub to remove foreign matter, such as food waste, left on the dishes, thereby automatically washing the dishes.

The dish washing machine is operated generally based on a washing cycle, during which washing water mixed with detergent is sprayed into a tub containing dishes to remove foreign matter left on the dishes, a rinsing cycle during which washing water not mixed with the detergent is sprayed into the tub to remove the remaining foreign matter and the detergent after performing the washing cycle, and a drying cycle for drying the dishes.

Recently, there has been developed a dish washing machine that is capable of heating washing water during the washing cycle to further increase the effectiveness of washing.

According to the conventional dish washing machine, the washing water is heated above a predetermined temperature level (approximately 80° C.) to sterilize germs on the dishes during the washing and/or rinsing cycles.

However, a heater is operated to heat the washing water, with the result that the energy consumption is increased.

### SUMMARY OF THE INVENTION

Accordingly, the present invention is directed to a controlling method for dish washing machine that substantially obviates one or more problems due to limitations and disadvantages of the related art.

An object of the present invention is to provide a controlling method for dish washing machine that is capable of accomplishing an excellent sterilizing effect while reducing energy consumption.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a controlling method for dish washing machine includes a spraying a washing water mixed with detergent in a tub containing dishes, a spraying a washing water not mixed with the detergent in the tub, a spraying steam in the tub, wherein the spraying a steam is operated after the spraying a washing water not mixed with the detergent, and a reducing humidity of the tub.

Preferably, the spraying steam heats a dish over a predetermined temperature.

Preferably, the spraying steam maintaining the temperature in the tub higher than the predetermined temperature for a predetermined time.

Preferably, the reducing humidity is operated substantially after the spraying steam.

In another aspect of the present invention, a controlling method for dish washing machine includes a washing cycle for washing a dirty dish, a rinsing cycle for rinsing the dish, wherein the rinsing cycle is operated after the washing cycle, a steam-sterilizing cycle for spraying steam to a dish, wherein the steam-sterilizing cycle is operated after the rinsing cycle, and a drying cycle for drying the dish, wherein the drying cycle is operated after the steam-sterilizing cycle.

Preferably, the steam-sterilizing cycle heats the dish over a predetermined temperature.

Preferably, the steam-sterilizing cycle maintains the temperature in the tub higher than the predetermined temperature for a predetermined time.

Preferably, the drying cycle is operated substantially after the steam-sterilizing cycle.

In the rinsing cycle, the washing water may not be heated. Alternatively, the washing water may be heated below 65° C. during the rinsing cycle.

In a further aspect of the present invention, a controlling method for dish washing machine includes a first period having a first variation rate of a temperature in the tub, wherein in the first period washing water not containing a detergent is sprayed in the tub, a second period having a second variation rate of a temperature, wherein in the second period steam is sprayed in the tub, a temperature of the tub increases higher than a predetermined temperature, and a third period decreasing the temperature in the tub continuously, wherein in the third period, air in the tub is exhausted outside.

Preferably, the controlling method for dish washing machine further includes a fourth period maintaining the temperature in the tub higher than the predetermined temperature for a predetermined time, wherein the fourth period is operated substantially after the second period.

Preferably, the third period is operated substantially after the fourth period.

Preferably, the second variation rate of a temperature is greater than the first variation rate of a temperature.

Preferably, the predetermined temperature is a temperature of sterilizing of germs on the dish.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a sectional view schematically illustrating an embodiment of a dish washing machine according to the present invention;

FIG. 2 is a graph illustrating operation cycles according to an embodiment of a controlling method of a dish washing machine of the present invention; and

FIG. 3 is a graph illustrating operation cycles according to another embodiment of a controlling method of a dish washing machine of the present invention.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

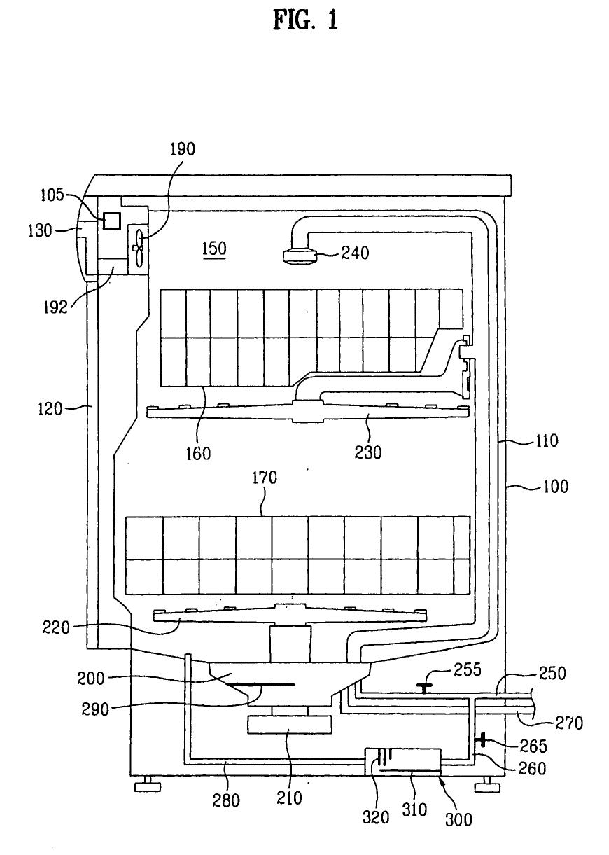

FIG. 1 is a sectional view schematically illustrating an embodiment of a dish washing machine according to the present invention.

Referring to FIG. 1, the dish washing machine according to the present invention includes a case 100 forming the external appearance of the dish washing machine, a door 120 for opening and closing the case 100, and a control panel 130 mounted at the case 100 or the door 120 for allowing a user to manipulate the dish washing machine.

In the case 100 is mounted a tub 110, which defines a washing chamber 150, i.e., a space for receiving dishes to be washed. Below the tub 110 is mounted a sump 200 for storing washing water.

The sump 200 includes a pump 210 for pumping the washing water stored in the sump 200 and a filter (not shown) for filtering contaminated washing water. The sump 200 further includes a sump heater 290 for heating the washing water stored in the sump 200.

To the sump 200 are connected a first water supply pipe 250, through which fresh water is supplied from an external water source, and a drainage pipe 270, through which the washing water in the sump 200 is drained to the outside. On the first water supply pipe 250 is mounted a first water supply valve 255 for controlling the supply of water into the sump 200.

In the tub 110, i.e., the washing chamber 150, are mounted at least one shelf and at least one spray arm for spraying the water pumped by the pump 210 toward the at least one shelf.

Specifically, as shown in FIG. 1, an upper shelf 160 and a lower shelf 170 are mounted at the upper part and the lower part of the washing chamber 150, respectively. Also, an upper spray arm 230 and a lower spray arm 220 are mounted at the upper part and the lower part of the washing chamber 150 for spraying the water pumped by the pump 210 toward the upper shelf 160 and the lower shelf 170, respectively.

In addition, a top nozzle 240, for spraying the water pumped by the pump 210 from the upper part to the lower part of the washing chamber 150, may be mounted in the upper part of the washing chamber 150.

In the dish washing machine according to the present invention, steam may be also sprayed or supplied into the washing chamber 150 by, for example, the pump 210 and the spray arms 230 and 220, in addition to the washing water sprayed into the washing chamber 150, or by a steam supply pipe 280 fed by a steam generator 300. To this end, the dish washing machine according to the present invention further includes a steam generator 300 which is driven separately from the sump heater 290 mounted in the sump 200.

As shown in FIG. 1, the steam generator 300 communicates with a second water supply pipe 260 and also communicates with the washing chamber 150 in the tub 110 via a steam supply pipe 280. On the second water supply pipe 260 is mounted a second water supply valve 265 for controlling the supply of water into the steam generator 300.

The steam generator 300 includes a steam heater 310 that is adapted to heat water supplied into the steam generator 300 and a water level sensor 320 that is adapted to sense the water level in the steam generator 300. The water level sensor 320 may sense, for example, a low water level and a high water level.

The low water level may be established to protect the steam heater 310 in the steam generator 300, and the high water level may be established to prevent an overflow of the water, supplied into the steam generator 300, from the steam generator 300.

Also, the steam generator 300 may further include a steam supply valve (not shown) for controlling the opening and closing of the steam supply pipe 280. The steam supply valve may be used to supply steam to the washing chamber 150 at a desired time.

In addition, the dish washing machine may further include a contamination sensor (not shown) adapted to sense the degree of contamination of washing water used to wash the dishes. In one embodiment, the contamination sensor may be mounted at one side of the sump 200 to enable it to sense the degree of contamination of washing water circulating in the tub 110.

At the door 120 are mounted a fan 190 and an exhaust duct 192 adapted to exhaust wet air from the washing chamber 150.

A control unit 105, adapted to control the dish washing machine, is electrically connected to electrically-operating components, such as the control panel 130, the pump 210, the water supply valves 255, 265, the fan 190, and the steam generator 300, to control the operation of the dish washing machine.

Operation modes to operate the dish washing machine may be decided depending upon a user's selection or the kind of dishes. Of course, the operation modes may be decided depending upon the contamination degree of the dishes. In other words, a plurality of operation modes may be established in the dish washing machine according to the present invention. Also, when an operation mode is decided, the number of rotations of the motor or the amount of detergent may be decided according to the decided operation mode.

Hereinafter, an operation process of the dish washing machine according to a controlling method for dish washing machine of the present invention will be described in detail.

The controlling method for dish washing machine according to this embodiment includes a washing cycle during which food waste left on dishes is removed from the dishes, a rinsing cycle, during which the dishes are rinsed, performed after the washing cycle, a sterilizing cycle for sterilizing the dishes by killing the germs on the dishes, and a drying cycle for drying the dishes.

Now, the respective cycles of the operation process will be described in detail.

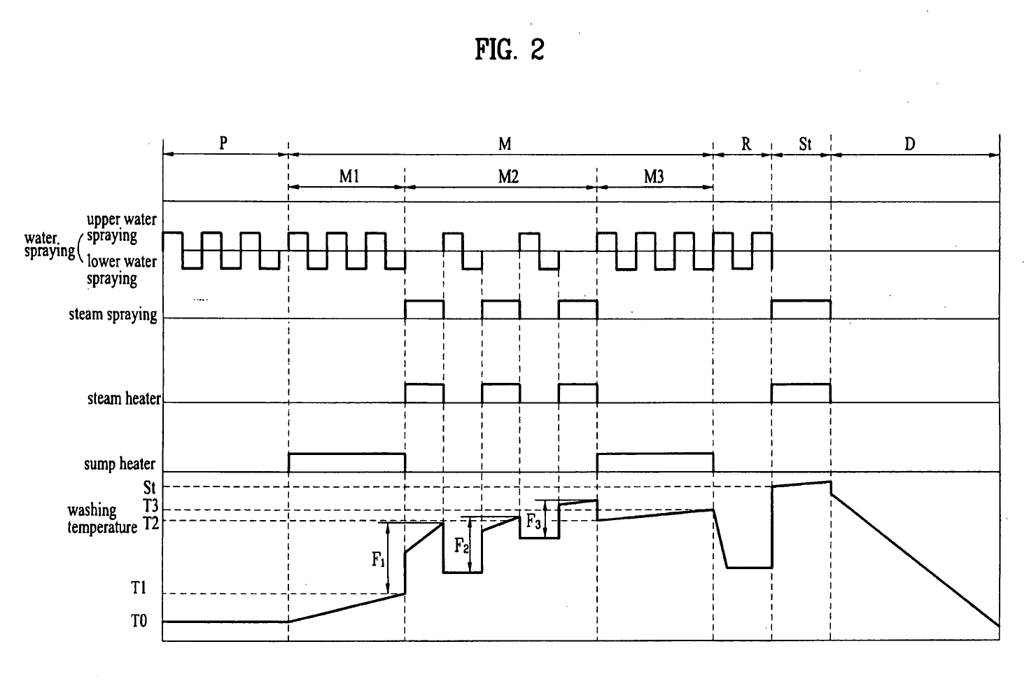

FIG. 2 is a view schematically illustrating operation cycles of the dish washing machine according to an embodiment of a controlling method for a dish washing machine of the present invention.

The washing cycle may generally include a preliminary washing cycle (P) and a main washing cycle (M).

The preliminary washing cycle (P) is a cycle for washing dishes using a washing water not mixed with detergent, and the main washing cycle (M) is a cycle for washing dishes using a washing water mixed with the detergent.

First, the water, introduced into the sump 200 from the outside, is supplied to the dishes, while the temperature of the water is low, without heating of the water during the preliminary washing cycle. The preliminary washing cycle is carried out to roughly remove foreign matter from the dishes.

At this time, the water may be alternately supplied into the upper spray arm 230 and the lower spray arm 220 such that the water is sprayed into the washing chamber. Specifically, the water spraying cycle carried out during the preliminary washing cycle (P) may be configured such that an upper water spraying cycle for supplying water through the upper spray arm 230 and a lower water spraying cycle for supplying water through the lower spray arm 220 are alternately carried out at the same time interval. For example, the upper water spraying cycle and the lower water spraying cycle may be alternately carried out several times at intervals of several minutes.

At this time, the steam heater 310 and the sump heater 290 are preferably not operated. Since the steam heater 310 and the sump heater 290 are not operated, the interior temperature of the washing chamber 150, into which the washing water is sprayed, is substantially equal to the temperature of the water supplied into the sump 200 from the outside.

Of course, the present invention is not limited to the above-described embodiment. For example, heated washing water may be supplied during the preliminary washing cycle (P). In addition, detergent may be contained in the washing water during the preliminary washing cycle (P).

After the completion of the preliminary washing cycle (P), the main washing cycle (M) is carried out. During the main washing cycle (M), a water spraying cycle and a steam spraying cycle are alternately carried out for a predetermined number of times.

The water spraying cycle is carried out to remove foreign matter from the dishes, whereas the steam spraying cycle is carried out to soak foreign matter left on the dishes such that the foreign matter is easily removed from the dishes.

In the water spraying process, the washing water is supplied into the upper spray arm 230 and the lower spray arm 220, which are alternately operated to spray the washing water to the dishes. At this time, the steam heater 310 and the sump heater 290 may not be operated. Consequently, the washing water is not heated during the water spraying process, and therefore, the atmospheric temperature of the washing chamber 150, i.e., the washing temperature, is not increased.

In the steam spraying process, on the other hand, the steam heater 310 is operated to generate steam, but the sump heater 290 may still not be operated. During the steam spraying process, the washing temperature is continuously increased.

Consequently, the operation of the sump heater 290, if energized, is terminated, and the steam heater 310 is periodically turned on/off, such that the steam and the washing water are alternately supplied to the dishes, during the main washing cycle (M). At this time, it is preferable to control the steam heater 310 and the sump heater 290 such that hey cannot be operated simultaneously. This is because, when the steam heater 310 and the sump heater 290 are operated simultaneously, instantaneous power consumption is greatly increased, which may be a problem.

Although the washing cycle includes the preliminary washing cycle (P) and the main washing cycle (M), as described above, the preliminary washing cycle (P) may be omitted, and therefore, it is possible to carry out only the main washing cycle (M).

After the completion of the main washing cycle (M), the circulated washing water is discharged outside through the drainage pipe 270, and a rinsing cycle (R) for supplying fresh water to the dishes is carried out. The rinsing cycle (R) is a cycle for spraying washing water that is not mixed with detergent onto the washed dishes several times through the upper spray arm 230 and the lower spray arm 220, to remove the foreign matter and detergent left on the dishes.

During the rinsing cycle (R), in one embodiment, the sump heater 290 is not operated. Therefore, the washing water is supplied without being heated by the sump heater 290. Although the unheated washing water is supplied to the dishes, the washing temperature of the washing chamber may be higher than the temperature when the washing cycle is initiated. This is because the temperature of the dishes or the inner temperature of the washing chamber to a specific temperature level cycle (M). That is because the temperature of the dishes or the inner temperature of the washing compartment 150 has already increased by a specified temperature through the main washing cycle M.

Of course, the operation of the steam heater 310 is not necessarily stopped during this portion of the cycle. According to circumstances, the sump heater 290 may be operated to heat the washing water, the dishes or the interior has already been increased through the main washing cycle (M) and the rinsing cycle (R). According to circumstances, the sump heater 290 may be operated to heat the washing water.

After the completion of the rinsing cycle (R), a cycle for draining the washing water and operating the steam heater 310 to discharge steam to the dishes may be carried out. This cycle is a sterilizing cycle (St) for discharging steam to the dishes to heat the dishes to more than a predetermined temperature level such that germs on the dishes are sterilized.

During this cycle, the dishes are preferably heated to more than a temperature at which the sterilization is carried out for more than a predetermined time. For example, when germs harmful to human bodies, such as food poisoning germs, exist on the dishes, most of the germs are known to die in 5 to 10 minutes at a temperature of 75 to 80° C. Consequently, the sterilizing cycle is configured such that the dishes are heated to more than 80° C. by the steam, and the temperature is maintained for approximately 5 to 10 minutes. Of course, the present invention is not limited to the above-specified condition, and therefore, application of various temperatures and times is possible.

Preferably, the sterilizing cycle (St) is carried out immediately after the completion of the rinsing cycle (R) at which the dishes are maximally washed.

After the completion of the sterilizing cycle (St), a drying cycle (D) for drying the sterilized dishes is carried out. The drying cycle (D) is a cycle for operating the exhaust fan 190, mounted in the dish washing machine, to continuously exhaust high-temperature wet air in the washing chamber 150 outside through the exhaust duct 192 such that the humidity in the washing chamber 150 is lowered to dry the dishes.

When the exhaust fan 190 is operated during the drying cycle (D), low-temperature air may be simultaneously suctioned from the outside, and the suctioned air may be mixed with the high-temperature wet air, suctioned from the washing chamber 150, such that moisture contained in the air is condensed.

Meanwhile, when moisture is left on the dishes for a long time, a possibility of germ repropagation is increased. Preferably, therefore, the drying cycle (D) is substantially carried out immediately after the completion of the sterilizing cycle (St) to prevent the recontamination of the dishes.

Of course, the present invention is not limited to the above-described procedure. For example, other cycles may be carried out between the sterilizing cycle (St) and the drying cycle (D).

According to the controlling method for dish washing machine of the present invention as described above, the sterilizing cycle (St), for discharging steam necessary for sterilization, is carried out after the completion of the rinsing cycle (R). Consequently, it is not necessary to heat the washing water for the purpose of sterilization during the rinsing cycle (R). Also, the amount of water heater is less when the dishes are heated by the steam than when the washing water is heated to heat the dishes to more than the sterilization temperature, whereby an energy saving effect is accomplished.

Also, the sterilization may be carried out with steam having a temperature higher than that of the heated washing water, and therefore, a sterilizing effect is further improved.

Hereinafter, the change in interior temperature of the washing chamber, when the dish washing machine is operated according to an embodiment of the present invention, will be described.

The following description will be made on the assumption that the washing cycle includes the preliminary washing cycle (P) and the main washing cycle (M).

During the preliminary washing cycle (P), the sump heater 290 is not operated, and therefore, washing water, supplied from the outside, is sprayed into the washing chamber 150 without being heated. Also, the steam heater 310 is not operated, and therefore, the interior temperature of the washing chamber 150 is equal to the temperature of the washing water supplied from the outside. That is, there is no change in interior temperature of the washing chamber 150.

When the main washing cycle (M) is carried out, the sump heater 290 is operated at a period of M1. Consequently, the washing water is heated, and therefore, the interior temperature of the washing chamber is increased to T1.

The steam heater 310 is operated at a period of M2, and therefore, the interior temperature of the washing chamber is increased. At the period of M2, a steam spraying process based on the operation of the steam heater 310 and a water spraying process through the upper spray arm 230 and the lower spray arm 220 may be alternately carried out.

Here, the steam spraying process is preferably stopped during the water spraying process.

The interior temperature of the washing chamber is gradually increased by the supply of the steam. For example, the washing temperature of the washing chamber during the steam spraying process may have a step shape in which the temperature is instantaneously increased as compared to the temperature during the water spraying process.

When the steam heater is operated, and therefore, steam is discharged into the washing chamber 150, the interior temperature of the washing chamber is sharply increased. This is because the steam, which is in a gaseous phase, more rapidly and uniformly spreads in the washing chamber 150, and the temperature of the steam is higher than that of the heated washing water. Also, the interior temperature of the washing chamber 150 is continuously increased during the generation of the steam.

When the washing water is sprayed, after the completion of the steam discharge, the interior temperature of the washing chamber 150 is abruptly lowered. However, the interior of the washing chamber 150 has been heated by the temperature of the steam, with the result that the interior temperature of the washing chamber 150 is lowered to a temperature slightly higher than the temperature before the steam is discharged.

The above-described processes may be repeatedly carried out several times. As a result, the interior temperature of the washing chamber is gradually increased, and therefore, the interior temperature of the washing chamber reaches a temperature of T2 at the end of the period of M2.

On the other hand, the amount of temperature increased F1, F2, and F3 during the spraying of the steam at the period of M2 may be gradually decreased. This is because the interior temperature of the washing chamber has already been increased to a specific temperature level with the progress of the steam spraying process, and therefore, the influence of a steam spraying process which will be subsequently carried out is somewhat decreased. That is, the temperature difference between the steam and the interior of the washing chamber is gradually decreased with the repetitive execution of the steam spraying process, and therefore, the amount of heat transmitted from the steam to the washing chamber is gradually decreased.

After the above-described process is carried out, the operation of the steam heater is stopped, and the sump heater is operated at a period of M3.

After the above-described process is carried out, an M3 cycle for stopping the operation of the steam heater and operating the sump heater may be carried out. During the M3 cycle, the discharge of steam is stopped, and the heated washing water is alternately sprayed through the upper spray arm and the lower spray arm.

Consequently, the interior temperature of the washing chamber 150 is increased.

In this embodiment, the washing cycle does not necessarily include periods of M1, M2, and M3. Consequently, it is possible for those skilled in the art to which the present invention pertains to appropriately modify the washing cycle.

When the rinsing cycle (R) is carried out, after the completion of the main washing cycle (M), the washing water, circulated during the main washing cycle (M), is drained through the drainage pipe 280, and fresh washing water is supplied to rinse the dishes.

At this time, the supplied washing water is not heated. Also, the sump heater 290 is not operated, and therefore, the interior of the washing chamber 150 is not heated. Consequently, the interior temperature of the washing chamber is not increased. Of course, the interior temperature of the washing chamber 150 may be lowered depending upon the temperature of the washing water supplied to the washing chamber 150, although not shown in the graph.

After the completion of the rinsing cycle (R), the sterilizing cycle (St) is carried out. During the sterilizing cycle (St), the steam heater 310 is operated, with the result that steam is discharged, and therefore, the interior temperature of the washing chamber is sharply increased. At this time, the interior temperature (Tst) of the washing chamber is preferably a temperature sufficient to sterilize germs on the dishes.

Specifically, the change in temperature of the washing chamber is maintained at a first variation rate during the rinsing cycle (R) of the dish washing machine. During the sterilizing cycle (St), the temperature of the washing chamber is increased to the temperature (Tst) sufficient to sterilize germs on the dishes at a second variation rate.

In this embodiment, the temperature of the washing chamber is not substantially changed during the rinsing cycle (R), and therefore, the first variation rate may be 0. Also, the second variation rate may be changed depending upon the temperature, pressure, and amount of steam sprayed, and therefore, the second variation rate cannot be particularly specified. However, those skilled in the art to which the present invention pertains may easily know the second variation rate.

At this time, the second variation rate of the temperature is preferably greater than the first variation rate of the temperature.

After the temperature is increased to the temperature (Tst) sufficient to sterilize the germs on the dishes at the second variation rate, a period in which the temperature of the washing chamber is maintained at more than the temperature sufficient to sterilize the germs on the dishes for a predetermined time may be provided.

Specifically, the temperature of the washing chamber is maintained at more than the temperature (Tst) sufficient to sterilize the germs on the dishes for a sufficient time, whereby a stronger sterilizing effect is accomplished.

In FIG. 2, the second variation rate of the temperature is shown nearly vertically. However, the second variation rate of the temperature is shown nearly vertically for convenience of description, and therefore, the temperature of the washing chamber may be increased at a variation rate less than the vertical level.

When the drying cycle (D) is carried out, the spraying of the steam is stopped, and the steam is drained out of the washing chamber, whereby the interior temperature of the washing chamber is lowered.

As the high-temperature wet air is continuously exhausted out of the washing chamber 150 by the exhaust fan 190 during the drying cycle (D), there is provided a period in which the interior temperature of the washing chamber 150 is continuously lowered to the room temperature.

Consequently, after the interior temperature of the washing chamber is increased to the temperature (Tst) sufficient to sterilize the germs on the dishes at the second variation rate, and the temperature of the washing chamber is maintained at more than the temperature (Tst) for a predetermined time such that the germs on the dishes are sterilized. Immediately after the sterilization of the germs on the dishes, the interior temperature of the washing chamber is lowered to the room temperature, and therefore, the dishes are cooled and dried. Consequently, it is possible to prevent the repropagation of germs, which may occur after the sterilization of the germs on the dishes.

In the controlling method for dish washing machine according to the present invention, therefore, steam is generated to sterilize the germs on the dishes during the rinsing cycle, instead of heating the washing water. Consequently, the present invention has the effect of accomplishing a sufficient steam effect through the heating of a reduced amount of the washing water, thereby accomplishing an energy saving effect. Also, it is possible to heat the dishes to a higher temperature, and therefore, the sterilizing effect is excellent.

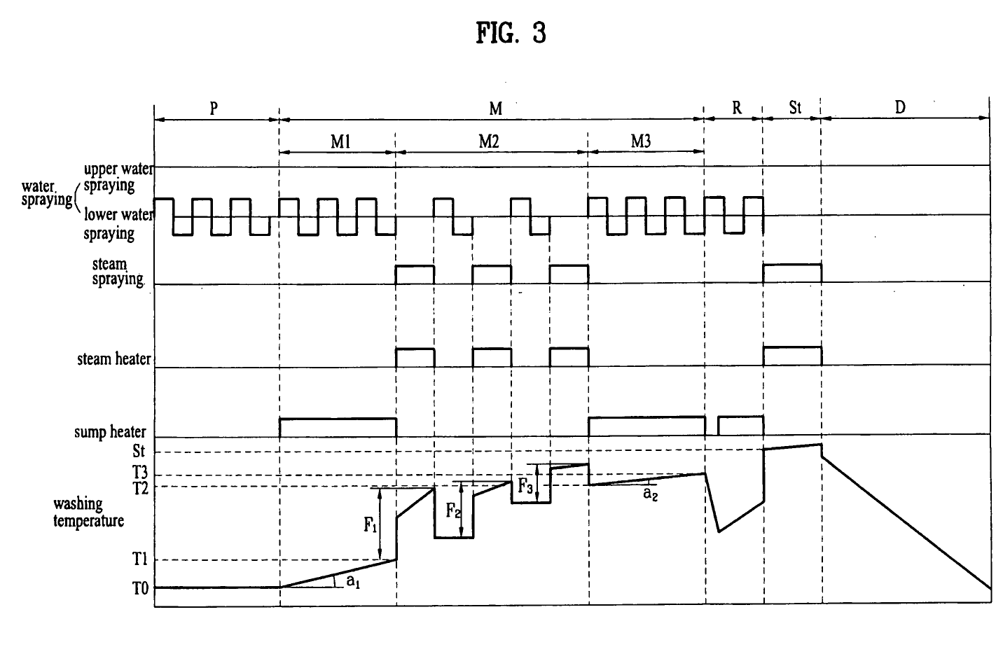

FIG. 3 is a view illustrating another embodiment of a controlling method for dish washing machine of the present invention.

This embodiment of the present invention is identical to the previous embodiment of the present invention except for a rinsing cycle (R) and a sterilizing cycle (St). In connection with this embodiment, therefore, only the rinsing cycle (R) and the sterilizing cycle (St) will be described in detail.

During the rinsing cycle according to the previous embodiment, the sump heater 290 was not operated, with the result that there was no change in temperature at the rinsing cycle. During the rinsing cycle according to this embodiment, however, the sump heater 290 may be operated.

Specifically, the sump heater 290 is operated to heat washing water, which will be sprayed into the washing chamber. Consequently, the interior temperature of the washing chamber is increased at a first variation rate during the rinsing cycle (R).

Here, the first variation rate of this embodiment may be different from that of the previous embodiment. Also, the temperature increased at the first variation rate during the rinsing cycle (R) is preferably below 65° C.

After the completion of the rinsing cycle (R), the sterilizing cycle (St) is carried out, with the result that the interior temperature of the washing chamber is increased to the temperature (Tst) sufficient to sterilize the germs on the dishes at the second variation rate, and then the interior temperature of the washing chamber is maintained at more than the increased temperature for the predetermined time, whereby the sterilization of the germs on the dishes is accomplished.

In this embodiment, the second variation rate of the temperature is also preferably greater than the first variation rate of the temperature.

In this embodiment, therefore, the washing water is heated during the rinsing cycle (R), and therefore, it is possible to completely remove foreign matter and detergent, left on the dishes, from the dishes.

Also, the washing water is heated to a temperature below the sterilizing temperature, and an additional steam spraying process is carried out for the purpose of sterilization. Consequently, an energy saving effect is accomplished as compared to when heating the washing water to a temperature above the sterilizing temperature.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A controlling method for a dish washing machine, comprising:
spraying washing water mixed with detergent into a tub containing dishes;
spraying washing water that is not mixed with the detergent into the tub;
spraying steam into the tub, wherein the spraying of steam is performed after the spraying of washing water that is not mixed with the detergent; and
reducing humidity within the tub.

2. The controlling method according to claim 1, wherein spraying steam heats a dish within the tub to a temperature that exceeds a predetermined temperature.

3. The controlling method according to claim 2, wherein spraying steam maintains the temperature in the tub at a level that is higher than the predetermined temperature for a predetermined time.

4. The controlling method according to claim 1, wherein reducing humidity is performed substantially after the spraying steam.

5. A controlling method for dish washing machine comprising:
performing a washing cycle adapted to wash a dish;
performing a rinsing cycle adapted to rinse the dish, wherein the rinsing cycle is operated after the washing cycle;
performing a steam-sterilizing cycle adapted to spray steam onto the dish, wherein the steam-sterilizing cycle is operated after the rinsing cycle; and
performing a drying cycle adapted to dry the dish, wherein the drying cycle is operated after the steam-sterilizing cycle.

6. The controlling method according to claim 4, wherein in the steam-sterilizing cycle heats the dish to a temperature that exceeds a predetermined temperature.

7. The controlling method according to claim 6, wherein the steam-sterilizing cycle maintains the temperature in the tub higher than the predetermined temperature for a predetermined time.

8. The controlling method according to claim 5, wherein the drying cycle is operated substantially after the steam-sterilizing cycle.

9. The controlling method according to claim 5, wherein in the rinsing cycle the washing water is not heated.

10. The controlling method according to claim 5, wherein in the rinsing cycle the washing water is heated below 6513.

11. A controlling method for a dish washing machine, comprising:
performing a first washing cycle during a first period, wherein the first period has a first variation rate of a temperature in the tub, wherein washing water for the first period does not contain a detergent;
performing a second washing cycle during a second period, wherein the second period has a second variation rate of a temperature in the tub, wherein in the second period steam is sprayed into the tub, a temperature of the tub increases higher than a predetermined temperature; and
decreasing the temperature in the tub continuously during a third period, wherein in the third period, air in the tub is exhausted outside.

12. The controlling method according to claim 11, further comprising:
maintaining the temperature in the tub higher than the predetermined temperature for a predetermined time during a fourth period in the tub, wherein the fourth period is performed after the second period.

13. The controlling method according to claim 12, wherein the third period is performed after the fourth period.

14. The controlling method according to claim 11, wherein the second variation rate of temperature is greater than the first variation rate of temperature.

15. The controlling method according to claim 11, wherein the predetermined temperature meets or exceeds a temperature required to sterilize a dish by killing germs on the dish.
